(19) United States
(12) Patent Application Publication
(10) Pub. No.: US 2016/0191573 A1
(43) Pub. Date: Jun. 30, 2016

(54) SYSTEMS AND METHODS FOR MODIFYING A STATE OF A SOFTWARE CLIENT

(71) Applicant: VONAGE NETWORK, LLC, Holmdel, NJ (US)

(72) Inventors: BOAZ ZEHAVI, JERSEY CITY, NJ (US); MARK WOOTTON, WALL, NJ (US); SOHEIL K. NAJAFABADI, KEW GARDENS, NY (US)

(21) Appl. No.: 14/586,431

(22) Filed: Dec. 30, 2014

(51) Int. Cl. H04L 29/06

(52) U.S. Cl. CPC H04L 65/1073; H04L 67/42; H04L 69/16

(57) ABSTRACT

A software client is connected to a computer server via a data transport medium. When the transport medium connection between the software client and the computer server is terminated, the computer server alters a registration status and/or a communication connection status of the software client.

### BACKGROUND OF THE INVENTION

The invention is related to computer systems that interact with software clients via data communications that pass over a data network. A transport medium is used to send data packets back and forth between the computer system and the software client. The software client typically registers with the computer system upon initial contact with the computer system, and the computer system maintains a list of all currently registered software clients and information about how to contact those registered software clients.

In many instances, the computer system requires the software client to send periodic communications to the computer system to maintain or refresh the software client's registration status with the computer system. If the computer system does not receive one of those communications within a predetermined period of time, the computer system automatically de-registers the software client.

The periodic communications that are sent from a software client to the computer system to maintain or refresh a registration with the computer system are done at a software application level. However, those periodic application layer communications are actually implemented as data packets that are communicated between the software client and an element of the computer system, typically a computer server, over a transport medium. One common example would be to send data packets from the software client to a computer server of the computer system via the Transmission Control Protocol (TCP) over an Internet Protocol (IP) data network.

More specifically, a software client would typically register with a computer system by first establishing a transport medium connection to a port of a computer server of the computer system. The software client then sends a registration request to the computer system. Communications may pass back and forth between the software client and the computer system as the registration process occurs. Once registered, the computer system alters the state of the software client in one or more internal databases to reflect that the software client is registered.

The computer server of the computer system also may exchange periodic communications with the software application to ensure that the transport medium connection that has been between established between the software client and the port of the computer server remains active. Typically, the communications that are used to maintain the transport medium connection between the software client and the port of the computer server occur more frequently than the periodic application layer communications that pass between the software client and the computer system to maintain the software client's registration status with the computer system. As a result, the computer server may determine that the transport medium connection between the software client and the port of the computer server has been terminated long before the computer system fails to receive a periodic communication from the software client that is used to maintain the software client's registration status. This means that the computer server is often aware that the software client is no longer reachable before the computer system becomes aware that the software client is unreachable.

### BRIEF DESCRIPTION OF THE DRAWINGS

FIG. 1 is a diagram of a communications environment including various elements which are associated with an Internet protocol (IP) telephony system in accordance with an embodiment of the invention;

FIG. 2 a diagram of various elements of a processor that forms part of an IP telephony system, a computer server, or a telephony device according to an embodiment of the invention;

FIG. 3 is a first diagram of logical connections that are made between two telephony devices through elements of an IP telephony system when a telephony communication is established between the two telephony devices;

FIG. 4 is a second diagram of an alternate set of logical connections that are made between two telephony devices through elements of an IP telephony system when a telephony communication is established between the two telephony devices;

FIG. 5 is a block diagram of selected elements of a computer server which can be part of an IP telephony system;

FIG. 6 is a block diagram of selected elements of an IP telephony system;

FIG. 7 illustrates steps of a method of altering the status or state of a software client when a change in a connection status of the software client over a transport medium is detected;

FIG. 8 illustrates steps of a first method of modifying a registration state of a software client, and a call state of a telephony communication, when a change in a connection status of the software client over a transport medium is detected; and

FIG. 9 illustrates steps of a second method of modifying a registration state of a software client and a call state of a telephony communication when a change in a connection status of the software client over a transport medium is detected.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

References to a “telephony device” and/or an “IP telephony device” appear in the following descriptions. This term is used to refer to any type of device which is capable of interacting with an IP telephony system to conduct a communication. An IP telephony device could be an IP telephone, a computer running IP telephony software, a telephone adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod touch™, which includes a speaker and a microphone. A software application loaded onto an Apple iPod touch™ can be run so that the Apple iPod touch™ can interact with an IP telephony system to conduct a telephone call.

The foregoing and following descriptions also refer to a “software client.” The software client could be any type of software application that is running on one or more processors of a computer device. In the context of this application, the software client is typically in communication with a “computer system.” The computer system could be any centralized computer system that is configured to perform any sort of purpose. The computer system could be comprised of one or multiple computer servers and other elements that are configured to interact with software client to achieve a particular portion. In some specific embodiments discussed herein, the software client is an IP telephony software client that is configured to interact with elements of an IP telephony system for the purpose of sending and receiving communications. However, the concepts and claimed subject matter is equally applicable to other type of software clients that interact with other types of computer systems. Thus, the discussion of IP telephony software client and IP telephony systems should in no way be considered limiting.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

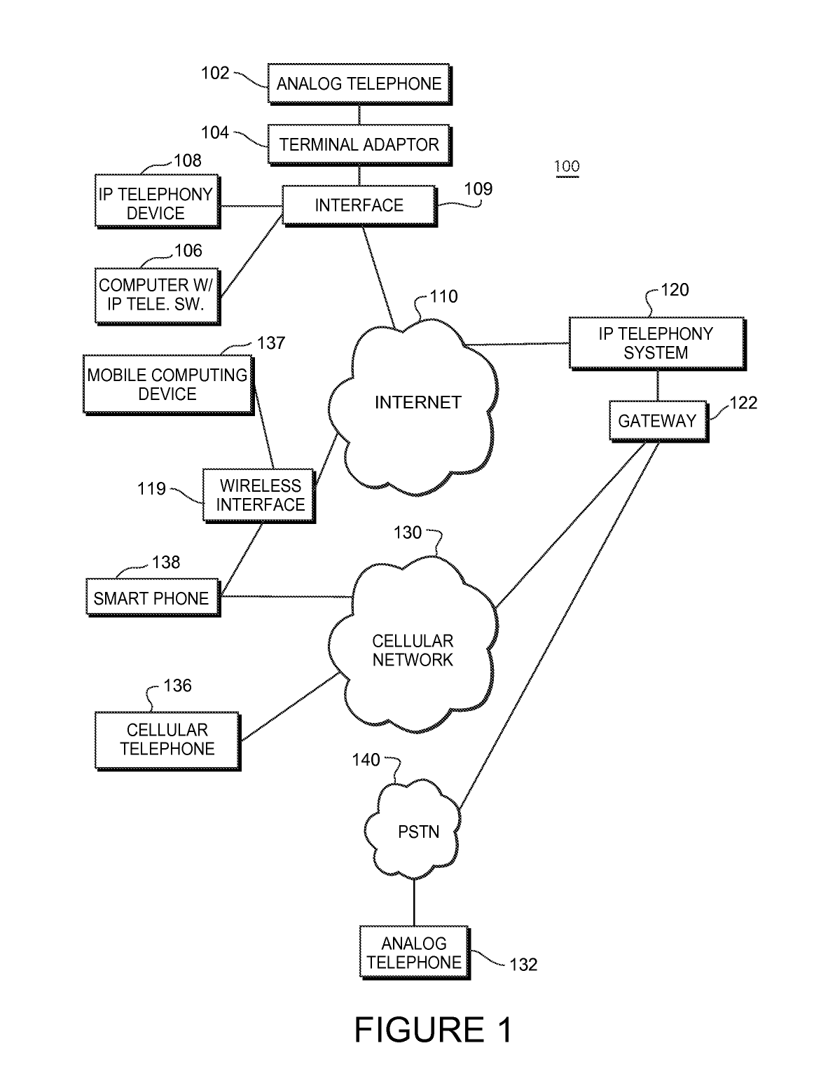

As illustrated in FIG. 1, a communications environment 100 is provided to facilitate IP based communications. An IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to a publicly switched telephone network (PSTN) 140 and/or a cellular network 130 via one or more gateways 122.

The gateway 122 allows users and devices that are connected to the PSTN 140 or cellular network 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110 via a data network interface 109. The IP telephone 108 could be connected to the data network interface 109 via a wired or wireless connection.

Alternatively, a customer could utilize a normal analog telephone 102 which is connected to the Internet 110 via a terminal adapter 104 and the data network interface 109. The terminal adapter 104 converts analog signals from the telephone 102 into data signals that pass over the Internet 110, and vice versa. Analog telephony devices include, but are not limited to, standard telephones and document imaging devices such as facsimile machines. A configuration using a terminal adapter 104 is common where the analog telephone 102 is located in a residence or business

In addition, a customer could utilize a computer that is running IP telephony software 106 to place and receive IP based telephone calls, and to access other IP telephony systems (not shown). Here again, the computer running IP telephony software 106 would access the Internet 110 via the data network interface 109. In some instances, the IP telephony software could be assigned its own telephone number. In other instances, the IP telephony software could be associated with a telephone number that is also assigned to an IP telephone 108, or to a terminal adaptor 104 that is connected to an analog telephone 102.

In addition, a mobile computing device 137 which is running IP telephony software could also be used to place and receive telephone calls through the IP telephony system 120. The mobile computing device 137 accesses the Internet 110 via a wireless data network interface 119. The wireless data network interface could be a WiFi or WiMax router, or any other type of wireless data interface device capable of communicating wirelessly with the mobile computing device 137.

A third party using an analog telephone 132 which is connected to the PSTN 140 may call a customer of the IP telephony system 120. In this instance, the call is initially connected from the analog telephone 132 to the PSTN 140, and then from the PSTN 140, through the gateway 122 to the IP telephony system 120. The IP telephony system 120 then routes the call to the customer's IP telephony device. A third party using a cellular telephone 136 could also place a call to an IP telephony system 120 customer, and the connection would be established in a similar manner, although the first link would involve communications between the cellular telephone 136 and a cellular telephone network 130.

A smart phone 138 which includes cellular telephone capabilities could also be used to conduct telephony communications through both the IP telephony system 120 and the cellular network 130. For example, an IP telephony software application running on the smart phone 138 could communicate with the IP telephony system 120 via the Internet 110. The smart phone 138 could access the Internet 110 via the wireless data network interface device 119, or via a data channel of the cellular network 130. Of course, alternate embodiments could utilize any other form of wired or wireless communications paths to enable communications.

Users of the IP telephony system 120 are able to access the service from virtually any location where they can connect to the Internet 110. Thus, a customer could register with an IP telephony system in the U.S., and that customer could then use an IP telephone 108 located in a country outside the U.S. to access the services. Likewise, the customer could also utilize a computer outside the U.S. that is running IP telephony software to access the IP telephony system 120. Further, in some instances a user could place a telephone call with the analog telephone 132 or the cellular telephone 136 that is routed through the PSTN 130 or cellular network 140 to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system 120 network. Thus, the user is able place a long distance call using lower cost IP telephony service provided by the IP telephony system 120, rather than a higher cost service provided by the PSTN 140 or cellular network 130.

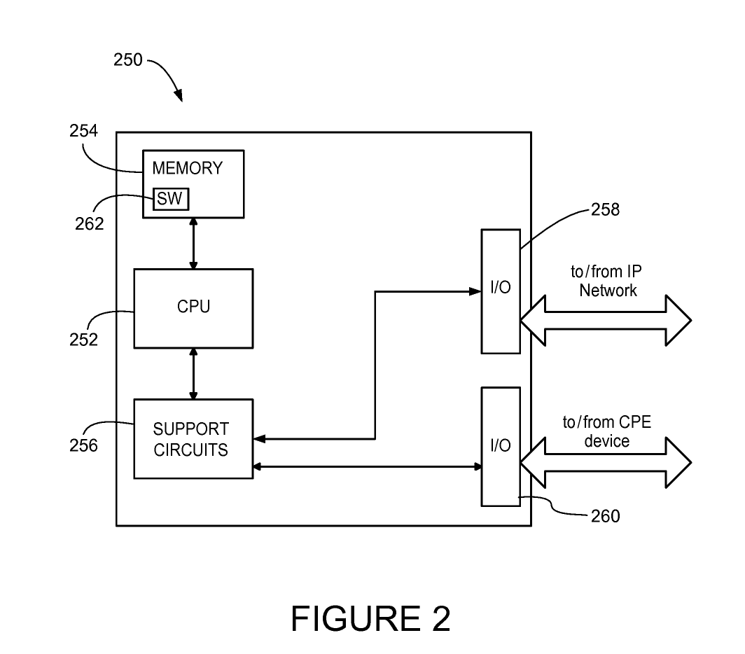

FIG. 2 illustrates elements of a computer processor 250 that can be used as part of the elements that make up an IP telephony system 120, or any of the telephony devices illustrated in FIG. 1. An element of an IP telephony system 120 or an IP telephony device would could include one or multiple processors 250, along with associated operating components and programming, each carrying out a specific or dedicated portion of the functions performed by the element of the IP telephony system 120 or the telephony device.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of an element of an IP telephony system 120 or a telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

In the communications environment illustrated in FIG. 1, an IP telephony software client could be loaded and running on the terminal adaptor 104, the IP telephony device 108, the computer 106, the mobile computing device 137, the smart phone 138 and the cellular telephone 136. Such an IP telephony software client would register with the IP telephony system 120. Such an IP telephony software client could then interact with various elements of the IP telephony system 120 to setup outgoing telephony communications, to receive incoming telephony communications and to perform other functions with the IP telephony system 120.

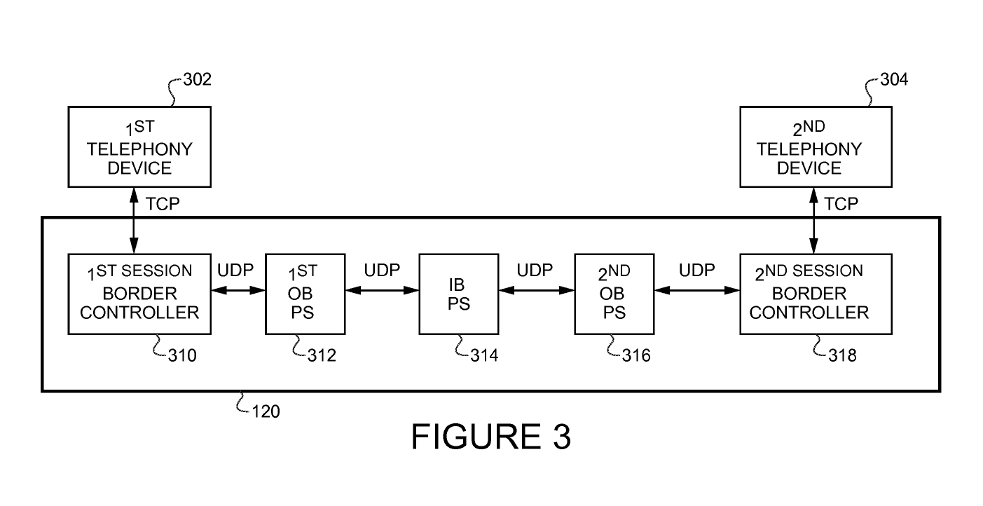

FIG. 3 illustrates a typical background art arrangement of elements of an IP telephony system 120 that are used to connect a first telephony device 302 to a second telephony device 304 so that the first and second telephony devices 302, 304 can conduct a telephony communication. IP telephony software clients would be running on each of the first and second telephony devices 302, 304, and the IP telephony software clients would be used to setup and conduct the telephony communication.

In order to setup a telephony communication between the first telephony device 302 and the second telephony device 304, the first and second telephony devices 302, 304 must be registered with the IP telephony system 120. To register, the first telephony device 302 establishes a transport medium connection to a port of a first session border controller 310. The transport medium connection is typically established via TCP over an IP data network, such as the Internet. The first telephony device 302 then sends a Session Initiation Protocol (SIP) registration message to the IP telephony system 120. The SIP registration message is received by the first session border controller 310, which passes the registration message along to a first outbound proxy server 312. However, the first session border controller 310 converts the SIP registration message from TCP format to User Datagram Protocol (UDP) format before passing it along to the first outbound proxy server 312. The first outbound proxy server 312 then communicates with the first telephony device 302 to register the first telephony device 302 with the IP telephony system 120. The messages sent from the first outbound proxy server 312 are sent in UDP format to the first session border controller 310, and the first session border controller 310 converts the messages into TCP format before sending them along to the first telephony device 302.

The second telephony device 304 would follow a similar procedure to setup a transport medium connection to a port of the second session border controller 318, and the second telephony device would then communicate with the second outbound proxy server 316 to register with the IP telephony system 120. The second session border controller 318 also translates TCP format SIP messages received from the second telephony device 304 into UDP format SIP messages before passing them along to the second outbound proxy server 316. The second session border controller 316 also translates UDP format messages received from the second outbound proxy server 316 into TCP format SIP messages before passing them along to the second telephony device 304.

Once the first and second telephony devices 302, 304 are registered with the IP telephony system 120, the first telephony device 302 can issue a SIP invite message to initiate the setup of a telephony communication with the second telephony device 304. The SIP invite message is passed from the first telephony device 302 to the first session border controller 310, then on to the first outbound proxy server 312 and on to an inbound proxy server 314. The inbound proxy server 314 then facilitates the setup of the telephony communication between the first telephony device 302 and the second telephony device 304.

As explained in the background section above, periodic communications are sent from the first telephony device 302 to the first outbound proxy server 312 to maintain or refresh the first telephony device's registration with the IP telephony system 120. At the same time, periodic communications are sent between the session border controller 310 and the first telephony device 302 to ensure that the transport medium connection between the first telephony device 302 and a port of the first session border controller 310 is maintained.

The periodic communications used to maintain the transport medium connection typically take the form of keep alive messages, which are exchanged on a regular schedule. If the first session border controller 310 fails to receive a periodic keep alive message from the first telephony device 310 within a predetermined period of time since the last keep alive message was received, the first session border controller 310 will make a determination that the transport medium connection has been lost. In other instances, the first telephony device 302 may send a communication to the first session border controller 310 to deliberately inform the first session border controller 310 that the first telephony device 302 is preparing to terminate the transport medium connection. In this instance, the first session border controller 310 may learn of the termination of the transport medium connection before it fails to receive a periodic keep alive message from the first telephony device 302.

In many instances, the periodic communications exchanged between the first telephony device 302 and the first session border controller 310 to maintain the transport medium connection between the first telephony device 302 and the first session border controller 310 occur more frequently than the periodic communications that are exchanged between the first telephony device 302 and the first outbound proxy server 312 to maintain or refresh the first telephony device's registration status with the IP telephony system 120. As a result, it is common for the first session border controller 310 to become aware of the fact that the IP telephony software application on the first telephony device 302 is no longer reachable before the first outbound proxy server 312 becomes aware of this fact.

In addition, the size of the periodic communications that are exchanged between the first telephony device 302 and the first session border controller 310 to maintain the transport medium connection between the first telephony device 302 and the first session border controller 310 are considerably smaller than the size of the periodic communications that are exchanged between the first telephony device 302 and the first outbound proxy server 312 to maintain or refresh the first telephony device's registration status with the IP telephony system 120.

In view of these aspects of the two sets of periodic communications, it would be desirable to rely upon the periodic communications that are exchanged to maintain the transport medium connection to the first telephony device 302 to also control the registration status of the first telephony device 302 with the IP telephony system 120. Operating in this fashion would likely result in the first telephony device's registration status being more rapidly updated when the IP software client on the first IP telephony device 302 is no longer reachable due to a failure of the transport medium connection to the IP software client. In addition, because the periodic communications that were previously being exchanged between the first telephony device 302 and the first outbound proxy server 312 would no longer be necessary, the system overhead required to communicate those periodic communications could be devoted to other purposes. Moreover, and as noted above, the size of the communications used to maintain the transport medium connection are smaller than the size of the communications previously used to maintain the first telephony device's registration status with the IP telephony system 120.

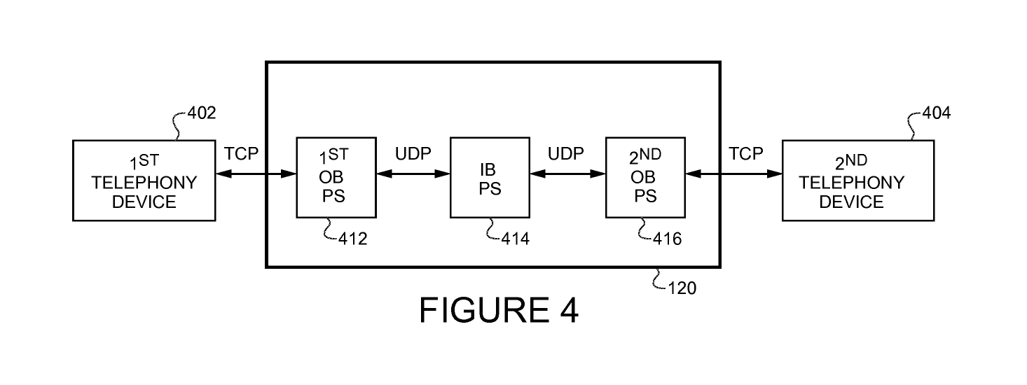

FIG. 4 illustrates an arrangement of elements of an IP telephony system 120 that is used to connect a first telephony device 402 to a second telephony device 404 so that the first and second telephony devices 402, 404 can conduct a telephony communication. In this new arrangement, session border controllers are no longer interposed between the first and second telephony devices 402, 404 and the first and second outbound proxy servers 412, 416. Instead, the first and second telephony devices 402, 404 communicate directly with the first and second outbound proxy servers 412, 416. The first and second telephony devices 402, 404 continue to send and receive TCP format SIP messages. As a result, the software in the first and second outbound proxy servers 412, 416 is updated to communicate with the first and second telephony devices 402, 404 via TCP format messages, although the first and second outbound proxy servers 412, 416 can continue to communicate with the inbound proxy server 414 using UDP format messages.

With an arrangement as shown in FIG. 4, the first telephony device 402 establishes a transport medium connection to a port of the first outbound proxy server 412. The transport medium connection is typically established via TCP over an IP data network, such as the Internet. The first telephony device 402 then registers with the IP telephony system 120 by communicating directly with the first outbound proxy server 412. The second telephony device 404 follows a similar procedure to setup a transport medium connection to a port of the second outbound proxy server 416, and the second telephony device 404 then communicates directly with the second outbound proxy server 416 to register with the IP telephony system 120.

The first and second outbound proxy servers 412, 416 periodically exchange messages with the first and second telephony devices 402, 404, respectively, to maintain the transport medium connections. If the first outbound proxy server 412 determines that it has lost its transport medium connection to the first telephony device 402, the first outbound proxy server 412 immediately causes the registration status of the IP software client on the first telephony device 402 to change from registered to not registered. The same procedures are followed by the second outbound proxy server 416 to monitor the transport medium connection it has established to the second telephony device 404, and to update the registration status of the IP software client on the second telephony device 404 when the transport medium connection is lost.

If an IP telephony software client on a user's telephony device is actively engaged in a telephony communication, the call state for that telephony communication will be listed as connected by the IP telephony system. If the outbound proxy server that is communicating with that IP telephony software client determines that the transport medium connection to the IP telephony software client has been lost, then in addition to causing the registration status of the IP telephony software client to change from registered to not registered, the outbound proxy server may also act to cause the connection status of the telephony communication to change from connected to disconnected.

Because the registration status of an IP telephony software client is being updated based on the more frequent periodic communications used to maintain the transport medium connections, in many instances, the registration status of an IP telephony software client will be updated more rapidly when the connection to the IP telephony software client is lost than would occur when the arrangement illustrated in FIG. 3 is used. Similarly, the connection status of any ongoing telephony communication may also be more rapidly changed from connected to disconnected.

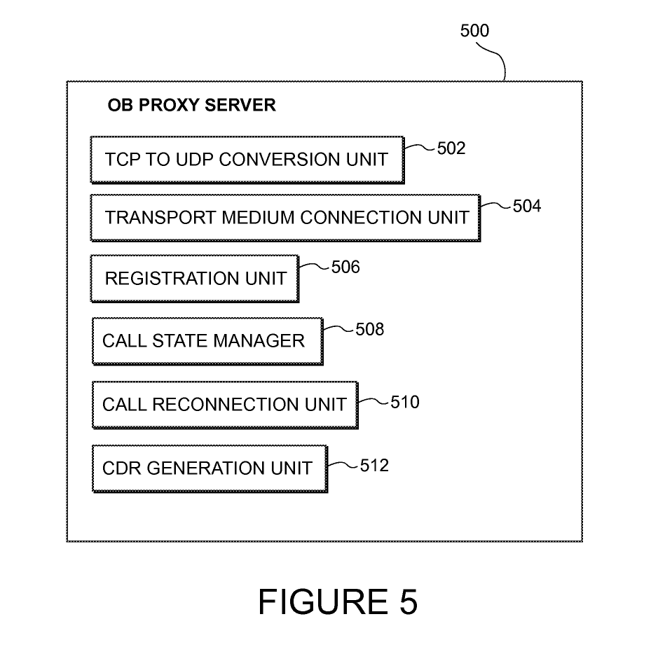

FIG. 5 illustrates selected elements of an outbound proxy server 500 that could be used in an arrangement as illustrated in FIG. 4. The outbound proxy server includes a TCP to UDP conversion unit 502, which converts messages received in one format to messages in the other format. This allows the outbound proxy server 500 to communicate with an IP telephony software client on a user's telephony device via TCP format messages, while communicating with elements of an IP telephony system 120 using UDP format messages.

The outbound proxy server 500 also includes a transport medium connection unit 504 that is responsible for establishing transport medium connections to IP telephony software clients on user telephony devices. The transport medium connection unit 504 also monitors the status of each transport medium connection that it sets up. As a result, the transport medium connection unit 504 knows when a transport medium connection to an IP telephony software client has been terminated.

The outbound proxy server 500 also includes a registration unit 506 that communicates with an IP telephony software client on a user's telephony device to register the IP telephony software client with the IP telephony system. In some embodiments, the registration status of an IP telephony software client may be tracked in one or more databases that are local to the outbound proxy server 500. In other embodiments, the registration status of IP telephony software clients may be tracked in one or more databases that are resident on other elements of the IP telephony system. In either case, however, when the transport medium connection unit 504 reports that a transport medium connection to an IP telephony software client has been terminated, the registration unit 506 takes steps to cause the registration status of the IP telephony software client to change from registered to not registered.

The outbound proxy server 500 further includes a call state manager 508. If an IP telephony software application has established a transport medium connection with the outbound proxy server, and is engaged in an ongoing telephony communication when the transport medium connection unit 504 reports that the transport medium connection has been terminated, the call state manager 508 takes steps to cause the call state for that telephony communication to change from connected to disconnected. The call state for the telephony communication could be tracked in one or more databases that are local to the outbound proxy server, or the call state could be tracked in one or more databases that are resident on other elements of the IP telephony system.

Although FIG. 5 shows an embodiment of an outbound proxy server that includes both a registration unit 506 and a call state manager 508, in alternate embodiments, the functions performed by these two units could be performed by other elements of the IP telephony system. In that case, the transport medium connection unit 504 would report the termination of a transport medium connection to an IP telephony software client to a registration unit and/or a call state manager on some other element of the IP telephony system, and those units would then cause the registration status of the IP telephony software client to change to not registered and/or cause the call state of an ongoing telephony communication to change to disconnected.

The outbound proxy server 500 also includes a call reconnection unit 510. The call reconnection unit 510 acts to try to reconnect an IP telephony software client after its transport medium connection has become disconnected. Ideally, a new transport medium connection to the IP telephony software client is quickly established so that an ongoing telephony communication can continue. Details about how the call reconnection unit 510 performs this function are discussed below.

The outbound proxy server also includes a call detail record (CDR) generation unit 512 that generates CDRs for communications that are conducted by IP telephony software clients which have established transport medium connections to the outbound proxy server 500. Those CDRs could include information about the duration of a telephony communication. With the old configuration as illustrated in FIG. 3, duration information in the CDRs that were generated for communications could occasionally be inaccurate because of a delay between the time that a transport medium connection to an IP telephony software client is terminated and the time that the call connection status is updated to reflect that the call has become disconnected. However, with an arrangement as illustrated in FIG. 4, the call connection status is more rapidly updated to reflect a disconnected status, and thus the telephony communication duration information appearing in the CDRs generated by the CDR generation unit 512 of the outbound proxy server tend to be more accurate.

The foregoing description of the elements of an outbound proxy server is not intended to be exhaustive. An outbound proxy server could include many other features in addition to those illustrated in FIG. 5 and discussed above. Thus, the foregoing description should in no way be considered limiting.

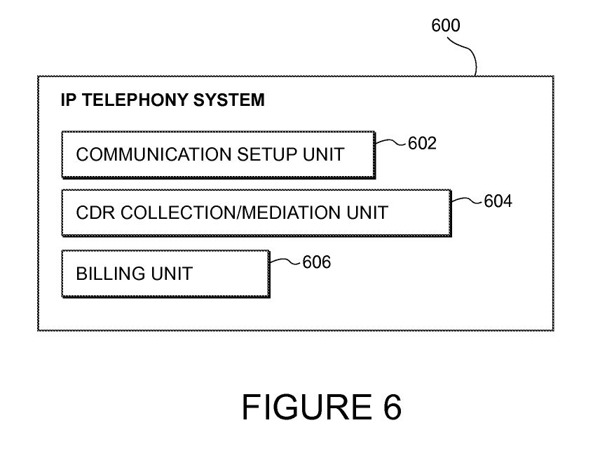

FIG. 6 illustrates selected elements of an IP telephony system 120. The IP telephony system includes a communication setup unit 602 that is responsible for facilitating the setup of new telephony communications for users of the IP telephony system 120. The IP telephony system also includes a CDR collection and mediation unit 604 that collects CDRs generated by various elements of the IP telephony system and which passes on information obtained from those CDRS to a billing unit 606. The billing unit then generates billing data for the communications that the IP telephony system has provided to its users.

The foregoing description of the elements of an IP telephony system also is not intended to be exhaustive. An IP telephony system would include many other features in addition to those illustrated in FIG. 6 and discussed above. Thus, the foregoing description should in no way be considered limiting.

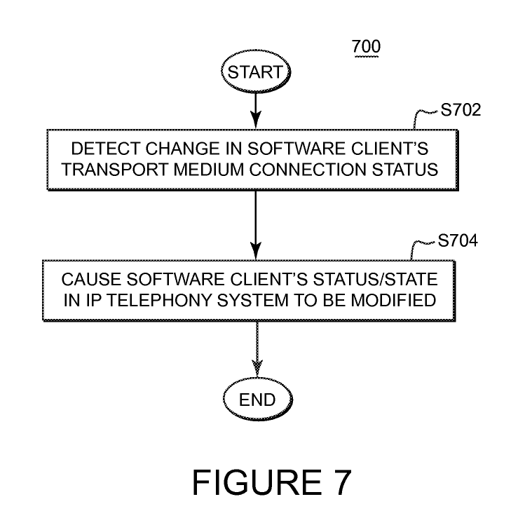

FIG. 7 illustrates steps of a first method for updating a software client's state or status based on a change in the software client's transport medium connection to an element of a computer system. The method 700 begins and proceeds to step S702 where a change in the software client's transport media connection to an element of the computer system is detected. This could be the termination of a transport medium connection to a port of a server. In other instances, the detected change could be the establishment of a new transport medium connection to an element of a computer system. In other instances, the detected change could involve some other type of change to a software client's transport medium connection.

The method also includes step S704, where a state or a status of the software client is changed based on the change in the transport medium connection detected in step S704. If the change detected in step S702 was the termination of a transport medium connection, step S704 could involve causing the registration status of the software client to change from registered to not registered. Conversely, if the change detected in step S702 is the establishment of a new transport medium connection step S704 could involve causing the registration status of a software client to change from not registered to registered.

The foregoing description of the method steps illustrated in FIG. 7 is given in a generalized fashion. This method could be performed for an IP telephony software client that is communicating with a server of an IP telephony system. However, the same basic method could be used in many other contexts.

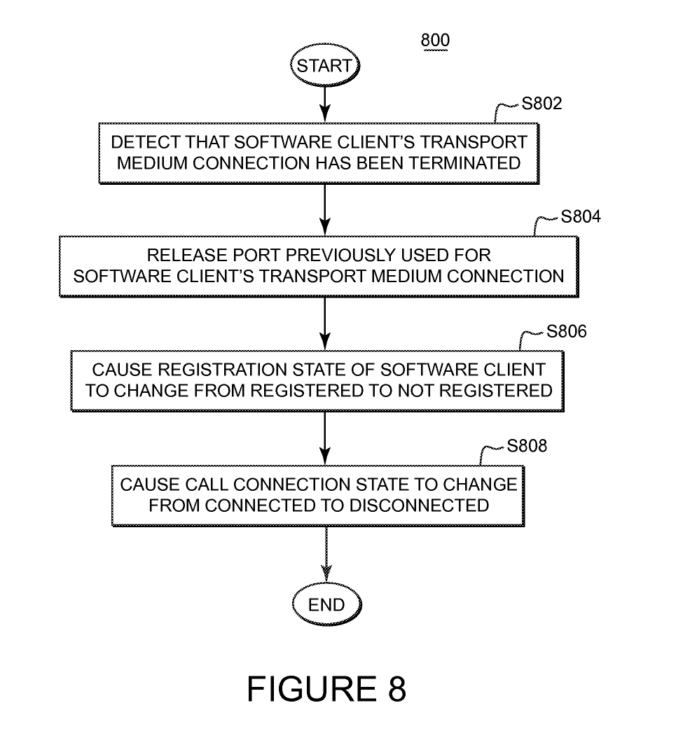

FIG. 8 illustrates steps of a more detailed method that could be performed by an outbound proxy server of an IP telephony system that is communicating with an IP telephony software client. Before the method 800 begins, an IP telephony software client will have established a transport medium connection to a port of an outbound proxy server of an IP telephony system. In some instances, the IP telephony software client may also have setup and be conducting a telephony communication before the method illustrated in FIG. 8 begins. The method 800 then begins and proceeds to step S802, where a transport medium connection unit of the outbound proxy server determines that the transport medium connection to the IP telephony software client has been terminated.

In step S804, the outbound proxy server releases the port that was previously used to communicate with the IP telephony software client so that it can be used for another purpose. In step S806, the outbound proxy server causes a registration status of the IP telephony software client to change from registered to not registered. Step S806 could be performed by a registration unit of the outbound proxy server. Alternatively, the transport medium connection unit of the outbound proxy server could report the termination of the transport medium connection to the IP telephony software client to some other element of the IP telephony system, and that other element could cause the registration status of the IP telephony software client to change to not registered.

If the IP telephony software client was engaged in an ongoing telephony communication at the time the transport medium connection was terminated, then in step S808 the outbound proxy server causes a connection status of the telephony communication to change from connected to disconnected. Step S808 could be performed by a call state manager of the outbound proxy server. Alternatively, the transport medium connection unit of the outbound proxy server could report the termination of the transport medium connection to the IP telephony software client to some other element of the IP telephony system, and that other element could cause the connection status of the IP telephony communication to change to disconnected. The method then ends.

Because the IP telephony software client might not be engaged in a telephony communication when the transport medium connection is terminated, step S808 is an optional step that might not be performed.

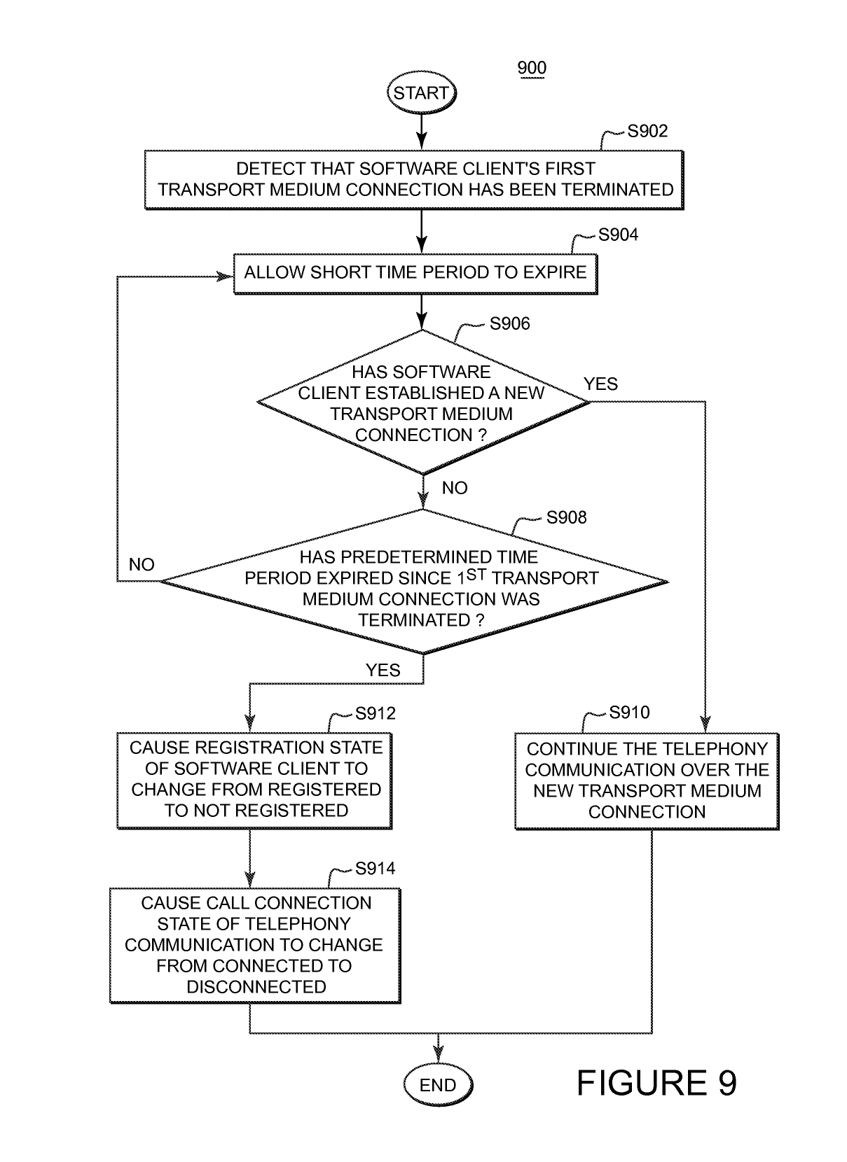

FIG. 9 illustrates steps of another method that could be performed by an outbound proxy server of an IP telephony system that is in communication with an IP telephony software client of user's telephony device. In this method, an IP telephony software client is conducting an ongoing telephony communication when the IP telephony software client's transport medium connection to an outbound proxy server becomes disconnected. The outbound proxy server waits for a predetermined period of time to see if the IP telephony software client attempts to establish a new transport medium connection with the outbound proxy server. If so, the outbound proxy server allows the telephony communication to continue using the new transport medium connection. If the predetermined period of time elapses before the IP telephony software client attempts to setup a new transport medium connection, the outbound proxy server causes the registration status of the IP telephony software client to change to not registered, and also causes the connection state of the telephony communication to change to disconnected.

Before the method 900 is performed, the IP telephony software client will have established a transport medium connection to a port of the outbound proxy server, and the IP telephony software client will have become involved in a telephony communication. The method 900 then begins and proceeds to step S902, where a transport medium connection unit of the outbound proxy server determines that the transport medium connection to the IP telephony software client has been terminated. In step S904, a short duration of time is allowed to expire. Next, in step S906, a check is performed to determine if the software client has attempted to setup a new transport medium connection to the outbound proxy server. If not, the method proceeds to step S908, where a check is performed to determine if a predetermined period of time has expired since the original transport medium connection was terminated. If not, the method loops back to step S904, and another short period of time is allowed to expire.

Steps S904, S906 and S908 are repeatedly performed until one of two conditions occurs. First, if the IP telephony software client sets up a new transport medium connection with the outbound proxy server before the predetermined period of time expires after the initial transport medium connection was terminated, then one performance of step S906 will result in a determination that the IP telephony software client has established a new transport medium connection to the outbound proxy server, and the method will proceed to step S910, where the telephony communication is allowed to continue over the new transport medium connection.

Second, if the predetermined period of time expires after termination of the initial transport medium connection without the IP telephony software client establishing a new transport medium connection to the outbound proxy server, the method proceeds to step S912, where the outbound proxy server causes the registration status of the IP telephony software client to change to not registered. Next, in step S914, the outbound proxy server causes a connection state of the telephony communication that was ongoing to change to disconnected. The method then ends.

The predetermined period of time mentioned above in connection with step S908 could vary. The aim, however, is to allow the software client sufficient time to setup a new transport medium connection, if it is possible to do so, before declaring the software client to be not registered and before the call state is changed to disconnected. The predetermined period of time must be long enough for the software client to go through the process of setting up a new transport medium connection, but also should be short enough that the call connection state is changed to disconnected before too much time expires, which helps to ensure that the billing for the actual duration of the telephony communication is reasonably accurate.

If an IP telephony software client attempts to setup a new transport medium connection to the outbound proxy server before the predetermined period of time expires after termination of the initial transport medium connection, the IP telephony software client may be required to provide the outbound proxy server with information that identifies itself, as well as information that identifies the telephony communication that was previously being conducted by the IP telephony software client. This information is used by the outbound proxy server to reconnect the IP telephony software client to the same telephony device with which it was previously communicating.

For example, if the IP telephony software client is communicating via Session Initiation Protocol (SIP) messages, the setup of the new transport medium connection and the continuation of the call could include a plurality of steps. First, the IP telephony software client would establish a new transport medium connection with an element of an IP telephony system, such as an outbound proxy server or a session border controller. Ideally, this transport medium connection is established to the same element of the IP telephony system with which the IP telephony software client was previously communicating. The new transport medium connection would likely be established on a different port of that element than was previously being used. The IP telephony software client then sends a SIP Re-INVITE message to the element of the IP telephony system. The element of the IP telephony system would challenge the SIP Re-INVITE message with a SIP 407 response. The IP telephony software client would then re-send the SIP Re-INVITE message with authentication headers. If a check of the authentication headers performed by the element of the IP telephony system passes, the element of the IP telephony system would accept the Re-INVITE message, and the IP telephony communication could continue over the new transport medium connection.

In many of the foregoing examples, an outbound proxy server acts to manage the registration status of a software client, and possibly the connection state of a telephony communication, based on a status of a transport medium connection that has been established between the software client and the outbound proxy server. However, in alternate implementations, these functions could be performed by a session border controller, such as the session border controllers 310 and 318 illustrated in FIG. 3. Thus, the foregoing descriptions, where the registration status and call connection state are managed by an outbound proxy server should in no way be considered limiting. These functions could be performed by any element with which a software client establishes a transport medium connection. Moreover, any element that has established a transport medium connection with a software client could pass along information about the status of that transport medium connection to one or more other elements that manage the registration status of the software client, or a connection state of telephony communication in which the software client is or was engaged.

As explained above, it can be advantageous to use the status of an IP telephony device's transport medium connection to an element of an IP telephony system to: (1) determine when to release a port of the element of the IP telephony system that was previously used to communicate with the IP telephony software client; (2) to determine when to cause the registration status of the IP telephony software client to change; and (3) to determine when to cause the connection status of an ongoing telephony communication to change to disconnected. Use of the status of the transport medium connection for these purposes can result in a more rapid update of key status information, as well as more accurate billing because the duration information for a telephony communication is likely to be more accurate.

Although the foregoing embodiments discussed an IP telephony software client communicating with an outbound proxy server, in alternate embodiments, the same or similar procedures could be performed by other elements of the IP telephony system. For example, if an IP telephony software client has established a transport medium connection with a port of a media relay, the media relay could perform the actions discussed above for an outbound proxy server.

Likewise, some of the description provided above refers to SIP application layer messages which are used to accomplish various functions. SIP is but one example of a communications protocol that could be used. In other instances, other types of communications protocols could be used.

Likewise, and as mentioned previously, the same or similar procedures would be performed to update the status of other types of systems that are in communication with a software client. Thus, the claimed methods are not limited to IP telephony systems.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method performed by a computer server for modifying a software client's state with respect to a system that registered the software client based on a status change in the software client's transport medium connection to the computer server, comprising:
detecting, at a computer server, a status change in a software client's transport medium connection to the computer server; and
causing the software client's state with respect to the system to be modified based on the detected status change in the software client's transport medium connection to the computer server.

2. The method of claim 1, wherein the software client is initially registered with the system and connected to the computer server via the transport medium, wherein the detecting step comprises detecting that the software client has lost its transport medium connection to the computer server, and wherein the causing step comprises causing the software client's registration state with respect to the system to change from registered to not registered.

3. The method of claim 1, wherein the system is a telephony system, wherein the software client is an IP telephony software client that is initially conducting a telephony communication via the telephony system and is connected to the computer server via the transport medium, wherein the detecting step comprises detecting that the IP telephony software client has lost its transport medium connection to the computer server, and wherein the method further comprises causing a connection state of the telephony communication to change from connected to disconnected.

4. The method of claim 3, wherein the IP telephony software client is a first IP telephony software client, and further comprising causing a message to be sent to a second IP telephony software client that was engaged in the telephony communication with the first IP telephony software client, the message indicating that the telephony communication has been terminated.

5. The method of claim 3, further comprising causing a message to be sent to a telephony device that was engaged in the telephony communication with the IP telephony software client, the message indicating that the telephony communication has been terminated.

6. The method of claim 3, further comprising causing teardown of the telephony communication.

7. The method of claim 3, wherein causing the software client's state with respect to the system to be modified comprises causing the IP telephony software client's registration state with respect to the telephony system to change from registered to not registered.

8. The method of claim 1, wherein the system is a telephony system, wherein the software client is an Internet Protocol (IP) telephony software client, and wherein causing the IP telephony software client's state with respect to the telephony system to be modified comprises causing the IP telephony software client's registration state with respect to the telephony system to change from registered to not registered.

9. The method of claim 1, wherein the transport medium connection between the computer server and the software client is implemented via the Transmission Control Protocol (TCP) over a data network.

10. The method of claim 1, wherein when the detecting step comprises detecting that the software client's transport medium connection to the computer server has been terminated, the method further comprises releasing a port of the computer server that was previously being used by the software client to communicate with the computer server via the transport medium.

11. The method of claim 1, wherein the system is a telephony system, wherein the software client is an IP telephony software client that is initially conducting a telephony communication via the telephony system and is connected to the computer server via the transport medium, wherein the detecting step comprises detecting that the IP telephony software client's transport medium connection to the computer server has been terminated, and wherein causing the IP telephony software client's state with respect to the telephony system to be modified comprises causing a registration status of the IP telephony software client with the IP telephony system to change from registered to not registered when the IP telephony software client does not attempt to establish a new transport medium connection to the computer server within a predetermined period of time after the first transport medium connection to the computer server was terminated.

12. The method of claim 11, further comprising resetting the transport medium connection between the IP telephony software client and the computer server when the IP telephony software client attempts to establish a new transport medium connection to the computer server within the predetermined period of time after the first transport medium connection to the computer server was terminated.

13. The method of claim 11, wherein the method further comprises causing a state of the telephony communication to change from connected to disconnected when the IP telephony software client does not attempt to establish a new transport medium connection to the computer server within a predetermined period of time after the first transport medium connection to the computer server was terminated.

14. The method of claim 11, wherein the method further comprises causing at least one setting of the IP telephony system to change to reflect that the telephony communication is to continue through the reset transport medium connection to the computer server when the IP telephony software client's transport medium connection to the computer server is reset after the IP telephony software client's first transport medium connection was terminated.

15. A non-transitory computer readable medium having instructions stored thereon which, when performed by one or more processors of a computer server, cause the computer server to perform a method comprising:
detecting a status change in a software client's transport medium connection to the computer server; and
causing the software client's state with respect to a system with which it is registered to be modified based on the detected status change in the software client's transport medium connection to the computer server.

16. The non-transitory computer readable medium of claim 15, wherein the software client is initially registered with the system and connected to the computer server via the transport medium, wherein the detecting step comprises detecting that the software client has lost its transport medium connection to the computer server, and wherein the causing step comprises causing the software client's registration state with respect to the system to change from registered to not registered.

17. The non-transitory computer readable medium of claim 1, wherein the system is a telephony system, wherein the software client is an IP telephony software client that is initially conducting a telephony communication via the telephony system and is connected to the computer server via the transport medium, wherein the detecting step comprises detecting that the IP telephony software client has lost its transport medium connection to the computer server, and wherein the method further comprises causing a connection state of the telephony communication to change from connected to disconnected.

18. The non-transitory computer readable medium of claim 17, wherein the IP telephony software client is a first IP telephony software client, and further comprising causing a message to be sent to a second IP telephony software client that was engaged in the telephony communication with the first IP telephony software client, the message indicating that the telephony communication has been terminated.

19. The non-transitory computer readable medium of claim 17, further comprising causing a message to be sent to a telephony device that was engaged in the telephony communication with the IP telephony software client, the message indicating that the telephony communication has been terminated.

20. The non-transitory computer readable medium of claim 17, further comprising causing teardown of the telephony communication.

21. The non-transitory computer readable medium of claim 15, wherein when the detecting step comprises detecting that the software client's transport medium connection to the computer server has been terminated, the method further comprises releasing a port of the computer server that was previously being used by the software client to communicate with the computer server via the transport medium.

22. The non-transitory computer readable medium of claim 15, wherein the system is a telephony system, wherein the software client is an IP telephony software client that is initially conducting a telephony communication via the telephony system and is connected to the computer server via the transport medium, wherein the detecting step comprises detecting that the IP telephony software client's transport medium connection to the computer server has been terminated, and wherein causing the IP telephony software client's state with respect to the telephony system to be modified comprises causing a registration status of the IP telephony software client with the IP telephony system to change from registered to not registered when the IP telephony software client does not attempt to establish a new transport medium connection to the computer server within a predetermined period of time after the first transport medium connection to the computer server was terminated.

23. The non-transitory computer readable medium of claim 22, wherein the method further comprises resetting the transport medium connection between the IP telephony software client and the computer server when the IP telephony software client attempts to establish a new transport medium connection to the computer server within the predetermined period of time after the first transport medium connection to the computer server was terminated.

24. The non-transitory computer readable medium of claim 22, wherein the method further comprises causing a state of the telephony communication to change from connected to disconnected when the IP telephony software client does not attempt to establish a new transport medium connection to the computer server within a predetermined period of time after the first transport medium connection to the computer server was terminated.

25. The non-transitory computer readable medium of claim 22, wherein the method further comprises causing at least one setting of the IP telephony system to change to reflect that the telephony communication is to continue through the reset transport medium connection to the computer server when the IP telephony software client's transport medium connection to the computer server is reset after the IP telephony software client's first transport medium connection was terminated.
